(19) United States
(12) Patent Application Publication
(10) Pub. No.: US 2016/0019830 A1
(43) Pub. Date: Jan. 21, 2016

(54) Large-area display system

(71) Applicant: KONINKLIJKE PHILIP N.V., Eindhoven (NL)

(72) Inventor: Lucas Josef Maria SCHLANGEN, Eindhoven (NL)

(21) Appl. No.: 14/782,086

(22) PCT Filed: Apr. 4, 2014
(86) PCT No.: PCT/EP2014/056838

§ 371 Date: Oct. 2, 2015

Related U.S. Application Data
(60) Provisional application No. 61/809,458, filed on Apr. 8, 2013.

(30) Foreign Application Priority Data
Apr. 15, 2013 (EP) 13163658.1

(51) Int. Cl. G09G 3/32

(52) U.S. Cl. CPC G09G 3/32; G09G 2340/12

(57) ABSTRACT

The invention relates to a large-area display system (1) comprising a pixelated first display layer (2), which contains a plurality of individually addressable light sources (7) for generating images of a low resolution on the first display layer (2). The system further comprises an at least partly optically transparent second display layer (5) for presenting an image of a high resolution, said second layer being positioned substantially parallel to the first display layer (2). The display system (1) is adapted such that the image of a low resolution and the image of a high resolution are mutually tuned. The invented display systems allow the viewers to perceive an enhanced visional 3D depth in the images produced by the display system.

### FIELD OF THE INVENTION

The present invention relates to a large-area display system, comprising a pixelated first display layer, which contains a plurality of individually addressable light sources for generating an image of a low resolution by the first display layer. Such a large-area display system may be attached to a wall, but may also be positioned as a self-supporting or free-standing (part of a) bill board.

### BACKGROUND OF THE INVENTION

A large-area display of the type mentioned in the opening paragraph is known per se. More specifically, the international patent application document WO2011/114263-A2, published in the name of the present Applicant describes such a display system, formed here as a light-emitting textile-based architectural element. This element comprises a textile sheet, which covers an area having boundaries defined by a frame. The textile is also tensioned by said frame, so that the textile sheet has a flat and even surface. The textile sheet contains a plurality of light sources (here LEDs), which are positioned at well-defined locations relative to each other. The LEDs may be addressed individually by means of electrical conductors, so that user defined-images of low resolution may be produced.

The inventors have observed that the low resolution images produced by the known display system are not optimally attractive. More particularly, they have found that viewers of the low resolution images displayed by the system experience only a limited perception of depth. This renders the display less attractive for a use as large-area information and/or entertainment display in waiting areas and promotional event areas.

### SUMMARY OF THE INVENTION

It is an object of the present invention to overcome or at least mitigate the above-mentioned problem by making the display systems more attractive for viewers. More particularly, the invention aims at improving the known display in such a manner that the viewers perceive an enhanced visional 3D depth in the images produced by the display system.

These and possible other objects of the invention are achieved by a large-area display system, comprising a pixelated first display layer, which contains a plurality of individually addressable light sources for generating an image of a low resolution on the first display layer, wherein the display system further comprises an at least partly optically transparent second display layer for presenting an image of a high resolution, said second layer being positioned substantially parallel to the first display layer, and wherein the display system is adapted to display at least one combined image comprising a mutually tuned image of a low resolution and of a high resolution. In the case the display system is adapted to display a dynamic presentation of combined images, then the image of a low resolution and the image of a high resolution are usually mutually tuned.

The invention is based on the recognition of the inventors that the depth experience of the known display system can be significantly improved by adding a second, largely or completely optically transparent display layer substantially parallel to the first display layer. Said second display layer should be able to present an image of a high resolution, which image is tuned with the image of a low resolution. In practice, the tuning of both types of images means that especially sections of both images which present parts or figures that are identical, similar or have a logical relationship, are mutually coincident. Just renewable text superimposed on an image is insufficient for this purpose. Some suitable examples of such a logical relationship are clouds slowly passing by a waiving tree and its moving shadow, a mountain view with grazing cows, or people walking through a shopping center. The expression “usually” in this respect means at least 50%, for example 70% or 90% or more, of the images and/or the time of the presentation. As a result of such usual mutual tuning of both images, an impressive depth experience is perceived by a view of the picture formed by the combined images. When the first display is looked at through the second display, the combination of the image of a high resolution on the second display layer and the image of a low resolution on the first display layer is observed as the combined image (also referred to as superimposed image).

It is observed that the surface of the large-area displays typically amounts to several square meters or more. Thus, large-area displays having a height of 2 meters or more by a width of 3 meters or more are well within the scope of the present invention. It is stressed that the image of a low resolution is typically produced by a plurality of LEDs having a pitch length (distance between nearest neighboring LEDs) of several centimeters. Said LEDs are positioned in a two-dimensional structure of rows and columns, so that at each crossing point between any row and any column an addressable LED is present. The pixels of the image of a high resolution have a pitch length which is, for example, at least 2 times or 10 times and preferably at least 20 times smaller than the pitch length of the mentioned LEDs to enhance the depth experience perception. Therefore, the image presented by the second display layer can be considered as a high resolution image.

The two display layers run substantially parallel to each other. Thus, in the case of flat display layers, the normal to both display layers will differ less than a few degrees. The present invention functions well in display systems having flat display layers. It is stressed, however, that the depth experience is also obtained in case that the display layers are slightly curved. In such a situation, both layers should still be substantially parallel (or have roughly the same surface curvature). For practical reasons, it is highly preferred that the second display layer is positioned between the first display layer and a viewer, so that for such viewer the second display layer is in front of the first display layer. Such practical reasons are that renewable (dynamic) images of low resolution are easier and cheaper to generate than dynamic images of high resolution. Furthermore dynamic images of low resolution generally are brighter than dynamic images of high resolution and thus said brighter images are better observable than images of less brightness through another display.

The second display layer should be at least partially optically transparent. This feature allows the image of a high resolution to be visible to a viewer who actually looks through the second display layer. As will be discussed below, the way in which the image of a high resolution is created forms an important factor in considering whether the second display layer should be partially or even completely transparent.

An embodiment of the invented display has the feature that the image of a low resolution is renewable. This feature causes that a viewer may perceive movement in the picture resulting from the mutually tuned and combined images produced by both display layers. The renewing or refreshing of the images of a low resolution will generally be performed with a frequency lower than 1 image per second, although the invention may also work well at lower frequencies. Preferably, a renewal frequency of 50 images per second may be applied. Using such a frequency has the advantage that it corresponds with the frequency of AC power supplies. Such a choice simplifies the implementation of the presently invented display system with widely used electrical current systems.

It is noted that the depth experience also exists if a long series of identical renewable images are created by the first display layer, so that a viewer in practice perceives a static or non-moving scene. The depth experience provided by the present invention also works in such static scenes. Such static scenes may also be obtained by stopping renewing the images of a low resolution for a certain period of time. The depth experience provided by the present invention also works for static scenes created in the latter way, wherein no renewal of images generated by any of both display layers occurs.

The second display layer is able to present a static or a relatively static image of a high resolution. This image is described as being relatively static with reference to the renewable images. Thus, the refreshing rate of the relatively static image of a high resolution is significantly lower than the refreshing rate of the renewable images of a low resolution. More precisely, the refreshing rate of the relatively static image is at least ten times, and preferably more than twenty times lower than the refreshing rate of the renewable images. In many practical situations, the refreshing rate of the relatively static images will approach to zero, so that a literally static image is presented by the second display layer. In such situation, a large photo print may be used in the second display layer.

An interesting embodiment of the presently invented large-area display system has the feature that the first display layer comprises a diffusor layer which is positioned in front of the light sources. The presence of such a diffusor layer increases the spreading or smearing-out of the light generated by the light sources, thereby lowering unwanted glare. This is especially useful in case LEDs are applied as the light sources. The diffusor layer may contain an optically transparent resin material (like polymethylmethacrylate or PMMA) in which scattering particles are comprised. As an alternative, the surface area of such transparent resin material may be roughened to obtain a certain degree of diffusion. Such a diffusor layer is preferably positioned between the first display layer and the second display layer.

Another interesting embodiment of the display system according to the present invention is characterized in that the second display layer comprises a plate of a resin material, preferably polycarbonate (PC), and more preferably polymethylmethacrylate (PMMA). In principle, the second display layer may comprise a plate of glass. Due to their relatively high specific gravity, display layers comprising glass are less preferred in the case of large-area displays systems, as such layers highly contribute to the total weight of the display system. Moreover, thinning the thickness of the glass layer to affects the weight of the second display layer also reduces its required rigid and solid structure. Therefore, plates of resin material such as (semi-)transparent plastics and other organic polymer materials are preferred. Good results may be expected when using plates of the widely used polycarbonate. Even better results can be obtained when plates of polymethylmethacrylate are applied in the second display layer. Display systems having this type of plate are less vulnerable when used in public places.

A further interesting embodiment of the invented display system has the characteristic that the image of a high resolution is detachably provided on the second display layer. This measure allows a relatively simple design of the display system and enables such relatively static image to be replaced in a rather simple way. Static images of a high resolution for use in this embodiment may be printed on a thin layer of an optically transparent material, like polyethylene (PE), polypropylene (PP) or polyvinylchloride (PVC). Such a layer printed with static images may subsequently be attached on the plate of the second display layer. Said thin layer printed with the static images may be in the form of a sticker having an adhesive layer, which sticker can be detachably glued onto the second display layer. Thus, in the display system according to this design, the static image of a high resolution need not be permanently displayed in the second display layer. In the display system according to this design, it is preferred that the second display layer is completely optically transparent.

A yet further embodiment of the invented display system has the feature that the display system comprises a projector for projecting the image of a high resolution on the second display layer. Such a projector may be positioned at some distance from the second display layer, for example in a ceiling or a wall of a building in which the display system is positioned. The projector thus allows projecting a static or relatively static image of a high resolution on the second display layer. Creating a picture in the second display layer by means of addressable high resolution pixels positioned in the second display layer itself is in principle also possible, but appears to be rather cumbersome and expensive in practice. A display system comprising a projector has the advantage that the static pictures can be renewed or refreshed in a relatively simple manner. The renewal frequency will preferably be lower than the renewal frequency of the images of a low resolution. Thus, removal of a sticker or even the complete second display layer in order to change the static image is not needed for the presently described design of the display system. In a preferred embodiment according to this design, the second display layer is not completely optically transparent in order to allow proper projection of the static image or picture of a high resolution in the latter layer.

Yet another interesting embodiment of the presently invented display system further comprises a controller capable of tuning the image of a high resolution and the image of a low resolution. The presence of such a controller may improve the quality of tuning, resulting in an improved depth experience of the images produced by the display system. The tuning of both types of images can be automated by means of the controller, so that a manual alignment of both types of images is not necessary.

A specific embodiment of the invented large-area display system described in the previous paragraph is characterized in that the controller is capable of retrieving and editing the data of the image of a low resolution s so as to produce a static image of a high resolution of the static image parts of the images of a low resolution, which static image of high resolution can be projected on the second display layer. In a display system of this design, certain parts of the consecutive renewable images of a low resolution that do not change during a certain period of time can be selected by the controller. Subsequently, the controller can create a static image of a high resolution of these parts, which static image is projected on the second display layer. Resolution enhancement techniques and related software needed for this measure are known to a person skilled in the art.

A further embodiment of the invented display system is characterized in that the first display layer and the second display layer are mutually separated by an average distance of at least 1 centimeter. Arranging both display layers at a certain fixed, mutual distance provides the advantage that the experienced depth perception for a viewer appears to be enhanced. A distance of 1 centimeter is a practical minimum distance needed for obtaining this effect. Especially displays having a larger surface area may be arranged at a larger mutual distance of for example 5 centimeters to obtain an optimal depth experience improvement. The space between both display layers will usually be filled with air. Such a separation of the first and the second display layer may be used in display systems having flat or slightly curved display layers.

According to another interesting embodiment of the invented display system the display comprises a controller capable of retrieving information of the image of a high resolution, editing this information into 3D depth information and combining this 3D depth information with the information of the images of a low resolution. Software which constructs 3D images from 2D images is known per se, for example from Stanford university (http://ai.standford.edu/˜asaxena/reconstruction3d) and from Cornell university (http://make3d.cs.conreell.edu). By using this software in the controller, the depth experience of the display system may be significantly increased in an automated manner. Moreover, the moving parts displayed by the display system can move in a more natural way relative to the static image parts. For example, objects that moves away from the viewer are experienced as becoming smaller by said viewer.

Another embodiment of the large-area display system according to the present invention has the feature that the display system comprises means capable to detect the presence of a viewer, which, upon activation, may initiate a predetermined series of renewable images of a low resolution. This feature ensures that important information embedded in the renewable images is displayed at the moment that a viewer comes within a certain distance from the display system. At that moment, the system detects the presence of the viewer, stops the presentation and starts it at a predetermined point where the important information is located. This feature is very important when certain relevant information need be given to a maximum number of viewers.

A further embodiment of the invented large-area display system has the feature that the display system further comprises means capable to detect a characteristic of the viewer, which, upon activation, feed the characteristic into a controller capable to select an image based on the characteristic of the viewer. This feature provides a certain amount of intelligence to the display system, which can select certain images based on a feature (for example the gender) of a viewer.

According to another interesting embodiment of the invented display system the second display layer comprises touch screen activation means, which, upon activation of the means, may initiate a predetermined series of renewable images of a low resolution. In this embodiment, a viewer may actively interact with the display system by touching a part of the second display layer. The touching of the screen by a viewer may initiate a “stop the presentation” and a “start at another part of the presentation”. The presence of two or more touch screen activation means allows the viewer to make certain choices, which may cause stopping of the presentation and (re)starting it at a point of a viewer's choice.

US20120139956A1 discloses an emissive display apparatus including display screen operable providing digital content and a thematic overlay positioned over the display screen for appearing opaque diffuse reflective when the display screen is in the off-state, and enabling visible emissive display content concurrently with diffuse reflective content when the display screen is in the on-state.

### BRIEF DESCRIPTION OF THE INVENTION

These and other aspects of the invention will be apparent from and elucidated with reference to the embodiments described hereinafter.

In the drawings:

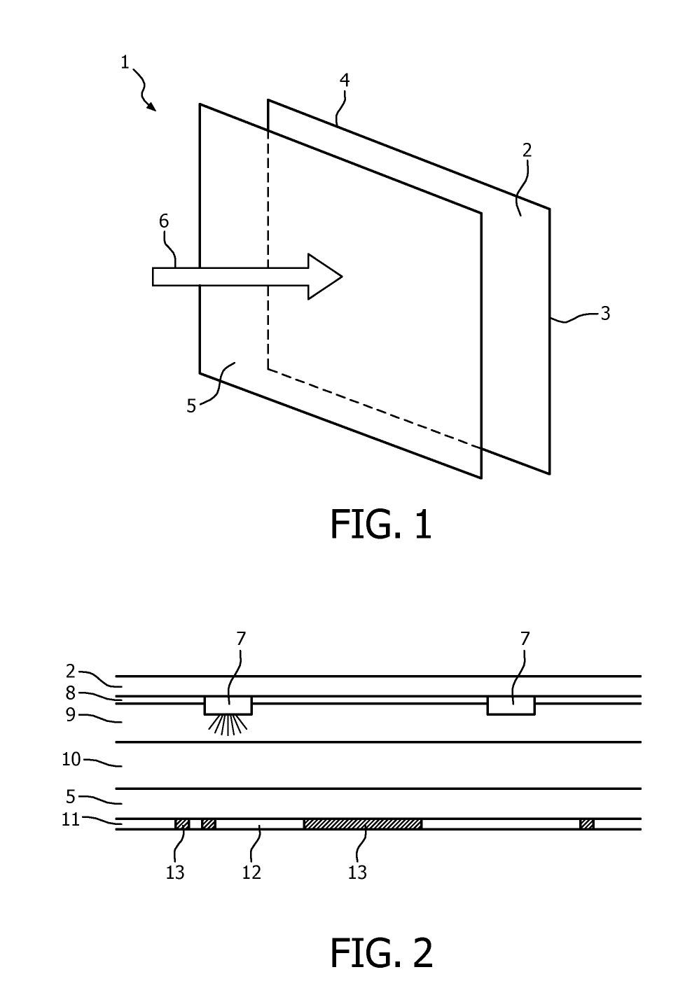

FIG. 1 shows a perspective view of a large-area display system according to the present invention,

FIG. 2 shows a cross-section of a part of the invented display system shown in FIG. 1, and

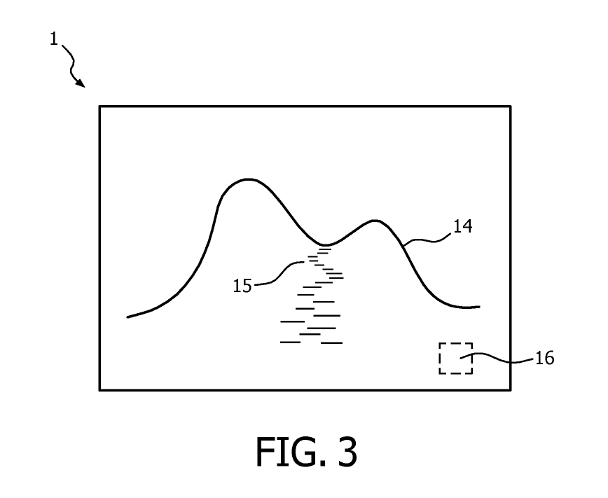

FIG. 3 shows a simple display image produced by the display system according to the present invention.

It is stressed that the drawings are schematic and not to scale. In the different Figures, the same elements are denoted by the same reference numbers.

### DETAILED DESCRIPTION OF EMBODIMENTS

FIG. 1 shows in schematic manner a perspective view of large-area display system 1 according to the present invention. The display system comprises a first display layer 2, which is composed of a textile sheet into which a plurality of individually addressable light sources (here LEDs) are embedded. Said sheet is tensioned by a metal frame (not shown), in order to produce a flat display layer. The LEDs (also not shown) are attached to the textile sheet, in which sheet also electrical conductor wires are comprised, which are needed for powering the individual LEDs.

The plurality of LEDs is systematically distributed over the sheet, so that parallel columns and parallel rows of LEDs can be distinguished. More particularly, the LED columns are arranged parallel to edge 3 of the display layer, whereas the LED rows are arranged parallel to edge 4 of the first display layer. The LEDs are disposed such that the distance of each LED to its nearest neighbor LED is approximately 4 centimeters. This distance (also called: pitch length) is the same for LEDs in the horizontal direction (rows) and the vertical direction (columns). Corresponding row conductors and column conductors arranged in the textile sheet provide for individual DC powering of the LEDs. By powering the LEDs, images of a low resolution can be created by the first display layer. These images can be renewed or refreshed with a certain frequency, so that images can be created which may be experienced as moving pictures by a viewer.

The display system also comprises a second display layer 5, which is made of a transparent material (here PMMA). First display layer 2 and second display layer 5 have dimensions of approximately 2 meters (width) by 1 meter (height) and are positioned parallel to each other at a mutual distance of approximately 2 centimeters. Both display layers may be interconnected by means of connections means present in at least the four corners of the display layers (not shown). A viewer who looks at the display system does so in the direction indicated by arrow 6, and observes that second display layer 5 is positioned in front of first display layer 2. A static image of a high resolution may be attached or projected on second display layer 5. According to an essential aspect of the invention, the images used during operation of the display system of both first display layer 2 and second display layer 5 are mutually tuned. This aspect will be elucidated in more detail with reference to FIG. 3.

FIG. 2 shows a cross-section of the display system 1 depicted in FIG. 1, which cross-section is taken in the horizontal direction. LEDs 7 are attached to first display layer 2 of textile. Row conductors 8 operate together with column conductors (not shown) in order to power the individual LEDs 7b by DC. These conductors are intertwined in the textile sheet of first display layer 2. Powering schemes needed in order to power the individual LEDs line-by-line are well-known to a person skilled in the art. Such powering schemes allow to refresh or renew the images produced by first display 2.

In front of LEDs 7, a diffusor layer 9 of translucent PMMA is attached. This layer causes the light generated by the LEDs to be somewhat diffused before it leaves first display layer 2. In front of diffusion layer 9, second display layer 5 of optically transparent PMMA is attached. Said second display layer 5 is separated by a distance layer 10 from first display layer 2 by a distance of approximately 2 centimeters. A static image 11 formed as a photo of a high resolution is positioned on the main surface of second display layer 5. In the depicted embodiment, said image 11 is printed on a thin layer of transparent material, which is glued on second display layer 5. This image 11 comprises both transparent area's 12 and diffuse area's 13 which are not fully transparent (or even completely non-transparent). The distance between the pixels of this static image is much—at least ten times and preferably at least twenty times—smaller than the distance of the nearest neighboring LEDs 7 present in first display layer 2.

FIG. 3 shows, in a schematic manner, an example of a simple superimposed image produced by display system 1 according to the present invention. This picture is seen by a viewer who looks in direction 6 at display system 1. Said superimposed image is built up of a static image of a high resolution, which image is presented by second display layer 5 and of renewable images of a low resolution, which images are presented by first display layer 2. More precisely, the static image shows only the contour 14 of mountains whereas the renewable pictures show both the contour 14 of the mountains and moving river 15 which flows from said mountains.

As indicated hereinabove, the display system is adapted such that the renewable images and the static image are mutually tuned. Specifically, in this embodiment, the moving parts present in the renewed images (the flowing river) are only presented by first display layer 2. However, the static parts present in both images (the contour of the mountains) are presented by first display layer 2 and second display layer 5, which static parts are superimposed and factually coincide for the viewer. Said static parts may be made to coincide in a manual way. However, said tuning of the images presented by both display layers may also be realized by means of a controller. Such a controller may be able to retrieve and edit the data of the renewable images in such a manner that it produces a static image of a high resolution of the static parts of the renewable images. Such a static image of high resolution may be projected on the second display layer in such a manner that the static parts of both images coincide.

The superimposed images generated by display system 1 according to the present invention are found to produce an impressive depth experience for a viewer. Said depth experience is inter alia dependent of the distance between first display layer 2 and second display layer 5. In a display system having a fixed distance between the display layers, an improved depth experience may be realized by means of editing the data of the images of a high resolution into 3D information. By means of a controller, this 3D information may be combined with the information of the renewable images already tuned.

The display system may also be provided with a system for presence detection, so that the presentation starts when the system notices a person within a certain distance from the display system. The presentation may even be selected based on a characteristic of such person. Second display layer 5 may also comprise touch screen activation means 16 for interactive communication between the viewer and display system 1.

It goes without saying that the display system according to the invention can be used for displaying a large variety of scenes. Few examples are 1) a person picking an apple (moving part) from a waiving tree (moving part), 2) walking persons (moving parts) along a road (static part), 3) people playing tennis (moving part) on a tennis court (static part), and 4) passing clouds (moving part) above a landscape (static part).

While the invention has been illustrated and described in detail in the drawing and foregoing description, such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure, and the appended claims.

In the claims, the word ‘comprising’ does not exclude other elements or steps, and the indefinite article ‘a’ or ‘an’ does not exclude a plurality. The mere fact that certain measures are recited in mutually different claims does not indicate that a combination of these measures cannot be used to advantage. Any reference signs in the claims should not be construed as limiting the scope of these claims.

1. Large-area display system, comprising a pixelated first display layer, which contains a plurality of individually addressable LED for generating a renewable image of a low resolution on the first display layer, wherein the display system further comprises an at least partly optically transparent second display layer for generating a relatively static image of a high resolution having a refreshing rate significantly lower than the refreshing rate of the renewable images of low resolution, said second layer being positioned substantially parallel to the first display layer, and wherein the display system is adapted to display at least one combined image comprising a mutually tuned image of a low resolution and of a high resolution,
wherein the first display layer is composed of a textile sheet in which the LEDs are embedded.

2. Display system according to claim 1, wherein the display system is adapted to display a dynamic presentation of combined images wherein the image of a low resolution and the image of a high resolution are usually mutually tuned.

3. Display system according to claim 2, wherein the second display layer is positioned in front of the first display layer, relative to a viewer.

4. Display system according to claim 3, wherein the image of a low resolution is renewable at a refreshing rate of at least 10 times, preferably at least 20 times, the refreshing rate of the images of high resolution.

5. Display system according to claim 4, wherein the first display layer comprises a diffusor layer which is positioned in front of the light sources.

6. Display system according to claim 5, wherein the second display layer comprises a plate a resin material, preferably polycarbonate (PC), and more preferably of polymethylmethacrylate (PMMA).

7. Display system according to claim 6, wherein the image of a high resolution is detachably provided on the second display layer.

8. Display system according to claim 7, wherein the display system comprises a projector for projecting the image of a high resolution on the second display layer.

9. Display system according to claim 8, wherein the display system further comprises a controller capable of tuning the image of a high resolution and the image of a low resolution.

10. Display system according to claim 9, wherein the controller is capable of retrieving and editing the data of the image of a low resolution so as to produce a static image of a high resolution of the static image parts of the image of a low resolution, which static image of a high resolution can be projected on the second display layer.

11. Display system according to claim 10, wherein the first display layer and the second display layer are mutually separated by an average distance of at least 1 cm.

12. Display system according to claim 11, wherein the display comprises a controller capable of retrieving information of the image of a high resolution, editing this information into 3D depth information and combining this 3D depth information with the information of the images of a low resolution.

13. Display system according to claim 12, wherein the display system comprises means capable to detect the presence of a viewer, which, upon activation, may initiate a predetermined series of renewable images of a low resolution.

14. (canceled)

15. Display system according to claim 14, wherein the second display layer comprises touch screen activation means, which, upon activation, may initiate a predetermined series of renewable images of a low resolution.

16. Display system according to claim 1, wherein the system comprises row conductors together with column conductors are intertwined in the textile sheet to power the LEDs.
